(19) United States
(12) Patent Application Publication
(10) Pub. No.: US 2026/0116025 A1
(43) Pub. Date: Apr. 30, 2026

(54) METHOD FOR MANUFACTURING A PROPELLER BLADE OR VANE WITH BONDING OF AN INSERT IN A DRY PREFORM

(71) Applicant: SAFRAN, PARIS (FR)

(72) Inventor: Marc WARIS, MOISSY-CRAMAYEL (FR)

(21) Appl. No.: 19/484,250

(22) PCT Filed: May 15, 2024
(86) PCT No.: PCT/FR2024/050623

§ 371 Date: Nov. 13, 2025

(30) Foreign Application Priority Data
May 16, 2023 (FR) FR2304843

(51) Int. Cl. B29C 70/48; B29B 11/16; B29L 31/08

(52) U.S. Cl. CPC B29C 70/48; B29B 11/16; B29L 2031/082

(57) ABSTRACT

A method for manufacturing a propeller blade or vane includes the production of a fibrous blank of an airfoil-shaped structure including an inner housing, the insertion of at least one insert into the inner housing with the interposition of an adhesive film between the insert and the inner housing of the fibrous blank so as to obtain a fibrous preform, the holding of the fibrous preform in a molding cavity of an injection tooling, the injection of a resin into the molding cavity containing the fibrous preform and the transformation of the resin into a matrix by heat treatment. The method further includes, after holding of the fibrous preform in the molding cavity and before injection of the resin into the fibrous preform, a procedure of pre-consolidating the adhesive film including at least the application of a consolidation pressure in the molding cavity.

### TECHNICAL FIELD

The present invention relates to the field of propeller blades or vanes for aircrafts such as those present on the turbomachines.

### PRIOR ART

In order to obtain lighter propeller blades or vanes, it is known to produce propeller vanes made of composite material, that is to say by producing structural pieces with fibrous reinforcement densified by a matrix.

Document US 2005/0084377 describes a method for manufacturing a turbomachine blade made of monolithic composite material, the blade being manufactured by three-dimensional weaving of a fibrous preform and densification of the preform with a matrix. This method allows obtaining blades with very high mechanical resistance, in particular with respect to shocks or impacts, without the risk of delamination. However, the manufacture of large monolithic propeller blades or vanes using this technique may be difficult.

Manufacturing methods for manufacturing blades or vanes with the introduction of one or more inserts into a dry fibrous preform have been developed.

Document US 2013/0017093 describes, for example, the production of a propeller vane from an airfoil-shaped fibrous structure into which part of a spar is inserted.

The bonding of the insert(s) in the dry fibrous preform is a delicate operation, particularly with regard to controlling the bonding interface. If the layer of adhesive material is not uniformly present between the preform and the insert(s), the quality of the bonding is degraded, which leads to a reduction in the mechanical strength. Since the dry fibrous preform is porous by nature, part of the adhesive film penetrates the preform by capillary action, resulting in an uneven adhesive film that can adversely affect the mechanical performance of the piece.

### DISCLOSURE OF THE INVENTION

It is therefore desirable to be able to propose a solution for the production of aircraft propeller blades or vanes that ensures uniform bonding over the entire interface between an insert and a fibrous preform.

To this end, the present invention proposes a method for manufacturing a turbomachine propeller blade or vane, the method comprising:
the production of a fibrous blank of an airfoil-shaped structure by three-dimensional weaving of yarns, the blank comprising an inner housing,
the insertion of at least one insert into the inner housing with the interposition of an adhesive film between the insert and the inner housing of the fibrous blank so as to obtain a fibrous preform,
the holding of the fibrous preform in a molding cavity of an injection tooling having the shape of the propeller blade or vane to be manufactured,
the injection of a resin into the molding cavity containing the fibrous preform and the transformation of the resin into a matrix by heat treatment, characterized in that the method further comprises, after holding of the fibrous preform in the molding cavity and before injection of the resin into the fibrous preform, a step of pre-consolidating the adhesive film comprising at least the application of a consolidation pressure in the molding cavity.

The application of a pressure in the molding cavity allows maintaining a pressure on the adhesive film through the dry fibrous blank and thus preventing the adhesive from flowing by capillary action into the porosity of the fibrous blank before injection of the resin.

According to one particular characteristic of the method of the invention, the application of the consolidation pressure in the molding cavity is carried out by injection of a pressurized inert gas into the molding cavity. This allows avoiding the risk of porosity mainly in the adhesive and possibly in the resin during its injection.

According to another particular characteristic of the method of the invention, the adhesive film comprises a layer of thermosetting epoxy resin.

According to another particular characteristic of the method of the invention, the adhesive film pre-consolidation step further comprises the partial polymerization of the adhesive film by application of a heat treatment. This partially stabilizes the bonding between the insert and the fibrous blank before injection of the resin. The adhesive film is preferably partially polymerized at a rate comprised between 20% and 50%. This allows optimizing the bonding of the insert by performing the other part of the polymerization of the adhesive film during the injection and final curing of the piece.

According to another particular characteristic of the method of the invention, the adhesive film further comprises a fibrous interface texture. The interface texture allows calibrating the thickness of the bonding interface between the insert and the fibrous blank.

According to another particular characteristic of the method of the invention, the material of said at least one insert is chosen among one of the following materials: metal material, composite or polymer material including a sealed surface coating.

### BRIEF DESCRIPTION OF THE DRAWINGS

FIG. 1 is a perspective view of an aircraft propeller vane in accordance with one embodiment of the invention,

FIG. 2 is a schematic view illustrating the 3D weaving of a fibrous blank for the manufacture of an airfoil-shaped structure of the propeller vane of FIG. 1,

FIG. 3A is a partial sectional view on an enlarged scale of a set of layers of yarns forming the blank of FIG. 1,

FIG. 3B is another partial sectional view on an enlarged scale of a set of layers of yarns forming the blank of FIG. 1,

FIG. 4 is an exploded view showing the production of a preform of the propeller vane of FIG. 1,

FIG. 5 is an exploded perspective schematic view showing an injection tooling and the placement of the preform of FIG. 4 therein,

FIG. 6 is a perspective schematic view showing the injection tooling of FIG. 5 closed during a pre-consolidation step of the adhesive film in accordance with one embodiment of the invention,

FIG. 7 is a perspective schematic view showing the injection tooling of FIG. 5 closed during a resin injection step,

FIG. 8 shows one example of the evolution of operating parameters during a pre-consolidation step of an adhesive film according to the invention.

### DESCRIPTION OF THE EMBODIMENTS

The invention applies generally to various types of propeller blades or vanes used in aircraft engines. The invention finds an advantageous but not exclusive application in large propeller blades or vanes intended to be integrated into pivoting or variable-pitch systems. Such propeller blades or vanes are generally provided with a root having both small space requirement (compact shape) and good resistance to tensile, bending and circumferential compression forces. The blade according to the invention may in particular constitute a blade for ducted rotor wheels such as fan blades or a blade for unducted rotor wheels as in the aeronautical engines called open rotor engines.

In the remainder of the description, one exemplary implementation of the method of the invention is described in relation to the manufacture of a turboprop engine blade. However, the exemplary embodiment also applies to the manufacture of a propeller vane for an aircraft turbomachine.

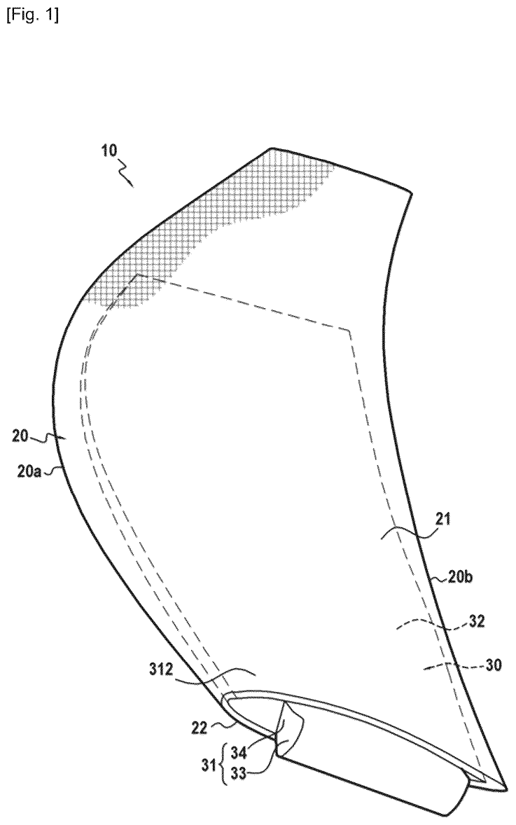

FIG. 1 represents a blade 10 intended to be mounted on an airplane turboprop engine which comprises, in a manner well known per se, an airfoil-shaped structure 20 intended to form the aerodynamic part of the blade, a root 33 formed by a thicker part, for example with a bulb-shaped section, extended by a stilt 34. The airfoil-shaped structure 20 has, in cross section, a curved profile of variable thickness between its leading edge 20a and its trailing edge 20b. The propeller vane 10 comprises a spar 30 comprising a first part 31 extending outside the airfoil-shaped structure 20 and including the root 33 and the stilt 34 and a second part 32 disposed inside the airfoil-shaped structure 20.

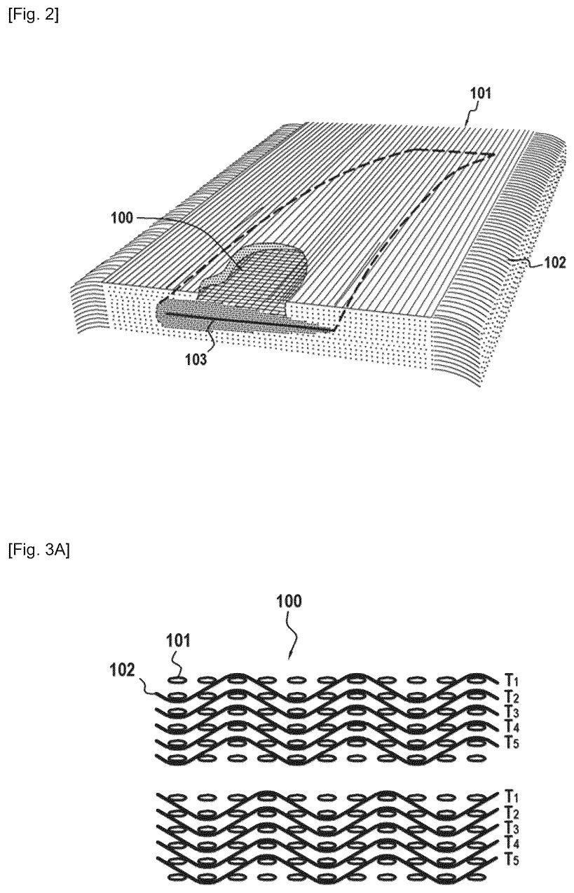

FIG. 2 shows very schematically a fibrous blank 100 intended to form the fibrous preform of the airfoil-shaped structure of the blade.

The fibrous blank 100 is obtained, as schematically illustrated in FIG. 2, by three-dimensional (3D) weaving performed in a known manner using a Jacquard-type loom on which a bundle of warp yarns 101 or strands has been disposed into a plurality of layers of several hundred yarns each, the warp yarns being interlinked by weft yarns 102.

In the illustrated example, the 3D weaving is an interlock weave. By “interlock” weave is meant a weave in which each layer of weft yarns interlinks a plurality of layers of warp yarns, with all of the yarns in the same weft column having the same movement in the weave plane.

Other known types of three-dimensional weaving may be used, such as in particular those described in document WO 2006/136755.

The fibrous blank may be woven from carbon fiber or ceramic yarns such as silicon carbide.

As the fibrous blank, whose thickness and width vary, is woven, a certain number of warp yarns are not woven, which allows defining the desired, continuously variable contour and thickness of the blank 100. One example of scalable 3D weaving, in particular making it possible to vary the thickness of the blank between a first edge intended to form the leading edge and a second edge of lesser thickness and intended to form the trailing edge, is described in document EP 1 526 285.

During weaving, a non-interlinking 103 (FIG. 2) is made inside the fibrous blank between two successive layers of warp yarns and on a non-interlinking area 104 (FIG. 4). The non-interlinking area 104 allows arranging an inner housing 104a for the introduction of an insert, here a spar, inside the fibrous blank 100 with a view to forming the preform of the airfoil-shaped structure.

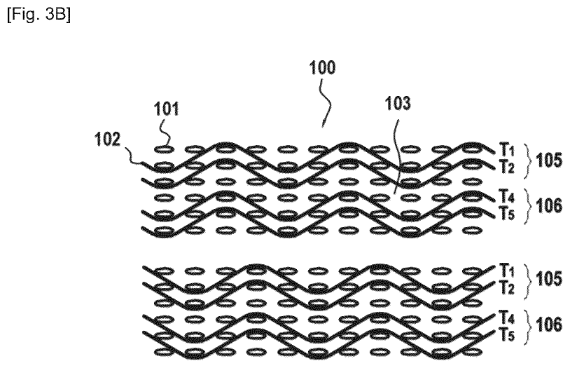

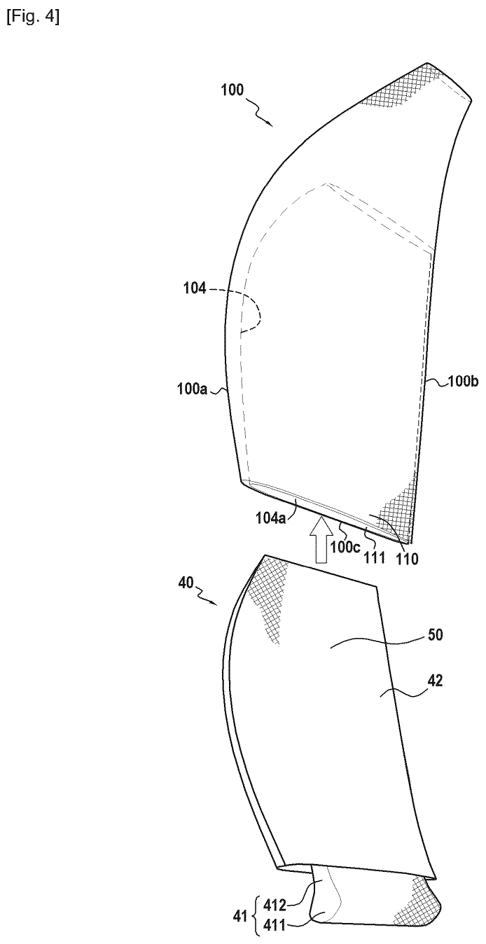

A blank 100 three-dimensional weaving mode with interlock weave is schematically shown in FIGS. 3A and 3B. FIG. 3A is an enlarged partial view of two successive warp sectional planes in a part of the blank 100 not having a non-interlinking, that is to say in an area of the blank located outside the non-interlinking area 104, while FIG. 3B shows two successive warp sectional planes in the part of the blank 100 having a non-interlinking 103 forming the non-interlinking area 104.

In this example, the blank 100 comprises 6 layers of warp yarns 101 extending in the direction X. In FIG. 3A, the 6 layers of warp yarns are interlinked by weft yarns T₁ to T₅. In FIGS. 3B, 3 layers of warp yarns 101 forming the set of yarn layers 105 are interlinked together by two weft yarns T₁, T₂, just as the 3 layers of warp yarns forming the set of yarn layers 106 are interlinked by two weft yarns T₄ and T₅. In other words, the fact that the weft yarns T₁, T₂ do not extend into the yarn layers 106 and that the weft yarns T₄, T₅ do not extend into the yarn layers 105 ensures the non-interlinking 103 which separates the sets of warp yarn layers 105, 106 from each other.

At the end of weaving (FIG. 2), the warp and weft yarns are cut at the limit of the woven mass, for example using a pressurized water jet, to extract the dry blank 100 represented in FIG. 4 as it is derived from the 3D weaving and before any shaping. The non-interlinking area 104 arranged during weaving allows forming two portions 110 and 111 woven independently of each other delimiting an inner housing 104a inside the blank 100. The two portions 110 and 111 are intended to form the skins 21 and 22 of the airfoil-shaped structure 20. The inner housing 104a is open on the lower edge 100c and on the rear edge 100b of the blank 100. The front edge 100a of the fibrous blank 100, which connects the two portions 110 and 111 and which is intended to form the leading edge 20a of the airfoil-shaped structure 20 of the blade 10 while the rear edge 100b of the blank 100 corresponds to the part intended to form the trailing edge 20b of the airfoil-shaped structure (FIG. 1).

In accordance with the invention, the manufacture of the blade comprises the use of an insert 40 corresponding here to a spar (FIG. 4).

The insert 40 comprises a first portion 41 and a second portion 42. The first portion 41, which corresponds to the first part 31 of the spar 30, includes a bulged part 411 and a part of decreasing thickness 412 intended to form respectively the root 33 and the stilt 34 of the blade 10 (FIG. 1). The part of decreasing thickness 412 is extended by the second portion 42, which corresponds to the second part 32 of the spar 30.

In the example described here, the insert 40 is made of metal material, for example titanium.

An adhesive film 50 is deposited over the entire surface of the second portion 42 of the insert, which corresponds to the part of the insert that is introduced into the inner housing 104a of the dry fibrous blank 100. Thus, an adhesive film is interposed between the insert and the wall of the inner housing 104a after insertion of the insert into the inner housing of the fibrous blank.

The adhesive film comprises a layer of thermosetting epoxy resin that may for example make the epoxy resin EA914 manufactured by the company Hysol®, correspond to the adhesive film AF191 manufactured by the company 3M®, to the adhesive film FM300 manufactured by the company Cytec®, or to the epoxy resin EA9396 manufactured by the company Hysol®.

In FIG. 4, the shaping of the dry fibrous blank 100 is carried out by introducing into the inner housing 104a the second portion 42 of the insert 40 covered with the adhesive film 50. A blade preform 200 is thus obtained comprising, along a longitudinal direction D_{L}, an airfoil-shaped preform part 211 constituted by the dry fibrous blank 100, in the inner housing 104 from which the second portion 42 of the insert 40 has been inserted. The adhesive film 50 is then interposed between the second portion 42 and the dry fibrous blank 100. The airfoil-shaped preform part 211 extends along a transverse direction D_{T} between a leading edge part 211a and a trailing edge part 211b.

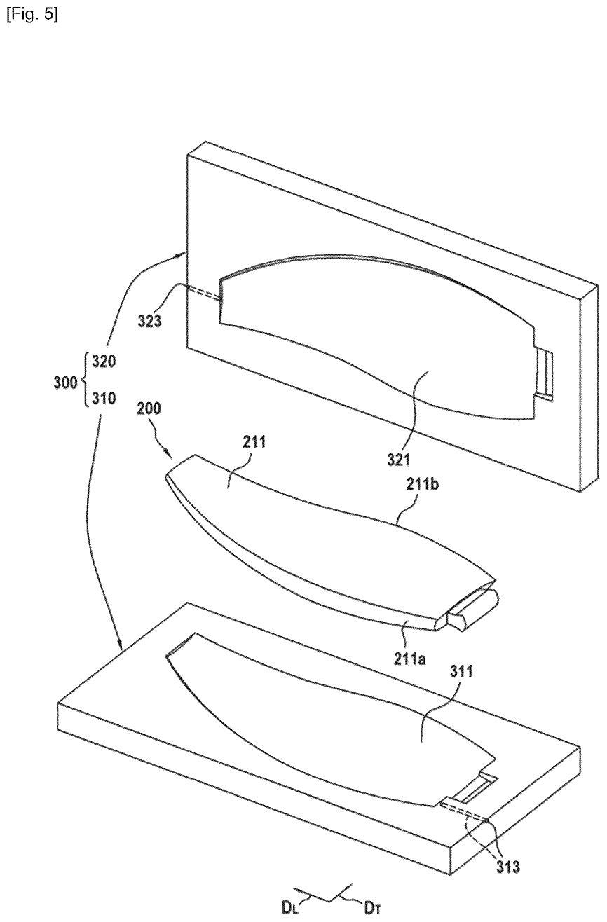

As illustrated in FIG. 5, the blade preform 200 is placed in an injection tooling 300 which comprises a first shell 310 comprising in its center a first footprint 311 partly corresponding to the shape and dimensions of the blade to be produced and a second shell 320 comprising in its center a second footprint 321 partly corresponding to the shape and dimensions of the blade to be produced.

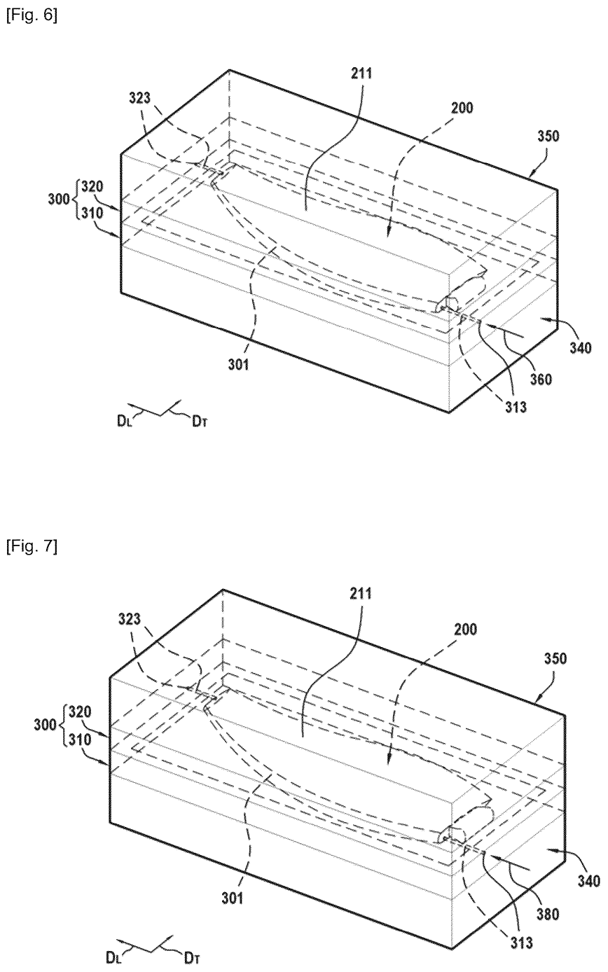

Once the tooling 300 is closed as illustrated in FIG. 6, the first and second footprints 311 and 321 respectively of the first and second shells 310 and 320 together define a molding cavity 301 having the shape of the blade to be produced and in which the preform 200 is held.

In accordance with the invention, a step of pre-consolidating the adhesive film is then carried out. In the example described here and as illustrated in FIG. 6, the pre-consolidation step comprises the application of a consolidation pressure in the molding cavity 301. For this purpose, a pressurized gas stream 360 is injected into the molding cavity through an injection port 313 present in the first shell 310 of the tooling 300. The pressure inside the molding cavity 301 can be regulated by a discharge port 323 present in the second shell 320.

The application of a pressure in the molding cavity 301 allows maintaining a pressure on the adhesive film through the dry fibrous blank and thus preventing the adhesive from flowing in the porosity of the blank. The pressure applied in the molding cavity during the pre-consolidation step can be comprised between 1 bar and 3 bars. The gas stream injected into the port 313 to apply the pressure in the molding cavity may be air or an inert gas such as nitrogen in order to limit the risk of porosity.

The application of consolidation pressure may be combined with partial polymerization of the adhesive film during the pre-consolidation step. In this case, a heat treatment cycle is further applied to the preform held in the injection tooling. The partial polymerization of the adhesive film allows increasing its creep resistance. In the example described here, the injection tooling 300 further comprises a lower part 340 and an upper part 350 between which the first and second shells 310 and 320 are placed, the lower part 340 and the upper part 350 being equipped with heating means (not represented in FIG. 6).

The duration and temperature step of the applied thermal cycle determine the level of polymerization of the adhesive. FIG. 8 shows one example of operating parameters used in a pre-consolidation step of the adhesive film (“Insert cycle in FIG. 8”) combining pressure application and partial polymerization thermal cycle. In this example, the adhesive is an adhesive film AF191 manufactured by the company 3M® and the pre-consolidation step is carried out over a period of approximately one hour during which the pressure in the molding cavity is brought to a value comprised between 1 bar and 3 bars while the preform is exposed to a temperature of 110° C. after a temperature rise. This allows obtaining a polymerization rate (α1) of the adhesive film of 25%.

In the case of application of a thermal cycle during the pre-consolidation step, the adhesive film is partially polymerized at a rate preferably comprised between 20% and 50%. This allows optimizing the bonding of the insert by carrying out the other part of the polymerization of the adhesive film during the injection and final curing of the piece.

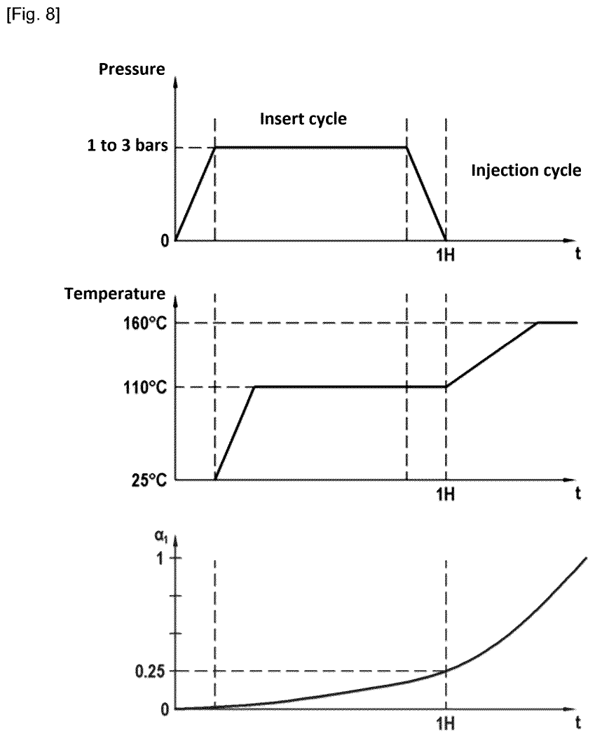

The fibrous part of the preform, here the shaped fibrous blank, is then densified, as illustrated in FIG. 7. The densification of the fibrous part of the preform consists in filling its porosity with the material constituting the matrix. This densification is performed in a manner known per se using the liquid process (CVL). The liquid process consists in impregnating the preform with a liquid composition containing a precursor of the material of the matrix. The precursor is usually in the form of a polymer, such as a high-performance epoxy resin, possibly diluted in a solvent.

The transformation of the precursor into a matrix, namely its polymerization, is carried out by heat treatment, generally by heating of the injection tooling, after removal of any solvent and crosslinking of the polymer, the preform being always held in the molding cavity having a shape corresponding to that of the piece to be produced.

In the case of formation of a carbon or ceramic matrix, the heat treatment consists in pyrolyzing the precursor to transform the matrix into a carbon or ceramic matrix depending on the precursor used and the pyrolysis conditions. For example, liquid ceramic precursors, in particular SiC, may be polycarbosilane (PCS), polytitanocarbosilane (PTCS) or polysilazane (PSZ) resins, while liquid carbon precursors may be resins with a relatively high rate of coke, such as phenolic resins. Several consecutive cycles, from impregnation to heat treatment, may be performed to achieve the desired degree of densification.

According to one aspect of the invention, in particular in the case of formation of an organic matrix, the densification of the fibrous preform may be performed by the well-known resin transfer molding (RTM) method. In accordance with the RTM method, the fibrous preform is placed in a mold having the external shape of the piece to be produced. A thermosetting resin is injected into the inner space of the mold that comprises the fibrous preform. A pressure gradient is generally established in this inner space between the location where the resin is injected and the resin discharge orifices in order to control and optimize the impregnation of the preform with the resin.

As illustrated in FIG. 7 and in accordance with the RTM method, a resin 380, for example a thermosetting resin, is injected via the injection port 313 of the first shell 310 into the molding cavity 301 occupied by the preform 200. The port 323 of the second shell 320 is connected to a discharge conduit maintained under pressure (not represented in FIG. 7). This configuration allows the establishment of a pressure gradient between the lower part of the preform 200 where the resin is injected and the upper part of the preform located in the vicinity of the port 323. In this way, the resin 360 injected substantially at the level of the lower part of the preform will gradually impregnate the entire fibrous part of the preform by circulating in it up to the discharge port 323 through which the surplus is discharged. Of course, the first and second shells 310 and 320 of the tooling 300 may respectively comprise several injection ports and several discharge ports.

The resin used may be for example an epoxy resin with a temperature class of 180° C. (maximum temperature tolerated without loss of characteristics). Resins suitable for the RTM methods are well known. They preferably have a low viscosity to facilitate their injection into the fibers. The choice of the temperature class and/or the chemical nature of the resin is determined based on the thermomechanical loads to which the piece must be subjected. Once the resin has been injected throughout the reinforcement, it is polymerized by heat treatment in accordance with the RTM method.

After injection and polymerization, the blade is demolded. Finally, the blade can be trimmed to remove excess resin, and the chamfers are machined. No further machining is necessary since, once the piece is molded, it meets the required dimensions. The blade 10 in FIG. 1 is then obtained.

The densification methods described above allow producing, from the fibrous preform of the invention, mainly propeller blades or vanes made of organic matrix composite (OMC), carbon matrix composite (C/C), and ceramic matrix composite (CMC) material.

According to one optional characteristic of the method of the invention, the adhesive film may further comprise a fibrous interface texture. The fibrous interface texture is a thin layer whose thickness allows defining or calibrating the thickness of the interface (adhesive joint) between the insert and the part of the fibrous blank with which the adhesive film is in contact. The thickness of the fibrous interface texture is preferably less than 1 mm. The fibrous interface layer may have various types of texture, such as in particular a marquisette, a two-dimensional woven fabric, a knit, a felt, a web, a braid, or a mat.

1. A method for manufacturing a turbomachine propeller blade or vane, the method comprising:
producing a fibrous blank of an airfoil-shaped structure by three-dimensional weaving of yarns, said blank comprising an inner housing, inserting at least one insert into the inner housing with the interposition of an adhesive film between the insert and the inner housing of the fibrous blank so as to obtain a fibrous preform,
holding the fibrous preform in a molding cavity of an injection tooling having the shape of the propeller blade or vane to be manufactured, injecting a resin into the molding cavity containing the fibrous preform and the transformation of the resin into a matrix by heat treatment, wherein the method further comprises, after holding of the fibrous preform in the molding cavity and before injection of the resin into the fibrous preform, pre-consolidating the adhesive film comprising at least the application of a consolidation pressure in the molding cavity.

2. The method according to claim 1, wherein the application of the consolidation pressure in the molding cavity is carried out by injection of a pressurized inert gas into the molding cavity.

3. The method according to claim 1, wherein the adhesive film comprises a layer of thermosetting epoxy resin.

4. The method according to claim 1, wherein the adhesive film pre-consolidation step further comprises partial polymerization of the adhesive film by application of a heat treatment.

5. The method according to claim 4, wherein the adhesive film is partially polymerized at a rate comprised between 20% and 50%.

6. The method according to claim 1, wherein the adhesive film further comprises a fibrous interface texture.

7. The method according to claim 1, wherein the material of said at least one insert is chosen among one of the following materials: metal material, composite or polymer material including a sealed surface coating.
